(19) United States
(12) Patent Application Publication
(10) Pub. No.: US 2026/0065793 A1
(43) Pub. Date: Mar. 5, 2026

(54) EDUCATIONAL DEVICE AND LEARNING METHOD

(71) Applicant: EDCLUB, INC., Rockville, MD (US)

(72) Inventors: Rostam Dinyarian, Rockville, MD (US); Armin Kiany, Rockville, MD (US); Ramin Gharei Kermani, Rockville, MD (US)

(21) Appl. No.: 18/819,014

(22) Filed: Aug. 29, 2024

(51) Int. Cl. G09B 1/06

(52) U.S. Cl. CPC G09B 1/06

(57) ABSTRACT

An educational device comprises a slide insert, wherein the slide insert has a holding portion and an insertion region, and one or more holes disposed within the insertion region; a slide insert holder, wherein a slot receptacle is configured at one end of the slide insert holder for receiving the slide insert, wherein the slide insert holder has one or more corresponding openings to the holes disposed in the slide insert; and one of more inserts; wherein the slide insert is inserted within the slot receptacle of the slide insert holder to form a slide insert and slide insert holder assembly, wherein one or more receptacles are formed by an alignment of the holes of the slide insert with the openings of the slide insert holder in the slide insert and slide insert holder assembly, wherein the one or more receptacles are configured to receive the one or more inserts.

### BACKGROUND

### Field of the Invention

The present disclosure relates generally to an educational learning resource. More particularly, the present disclosure relates to an educational learning device that can facilitate spelling within a learning and gaming environment.

### Background of the Invention

Existing learning systems, tools, and devices may prove too complicated and/or insufficient in providing practical applications for learning how to spell or associating objects with their correct spelling. Therefore, a need exists for providing educational devices to facilitate learning including, but not limited to, spelling of words and learning and associating objects in accordance with the same. An additional need exists for learning applications including learning locations of controls on devices utilizing lettering, numbering and special characters such as on keyboards. A further need exists for encouraging learning in a fun environment such as within a gaming method and/or providing a gaming device.

### SUMMARY

According to first broad aspect, the present disclosure provides an educational device comprising: a slide insert, wherein the slide insert has a holding portion and an insertion region, and one or more holes disposed within the insertion region; a slide insert holder, wherein a slot receptacle is configured at one end of the slide insert holder for receiving the slide insert, wherein the slide insert holder has one or more corresponding openings to the holes disposed in the slide insert; and one of more inserts; wherein the slide insert is inserted within the slot receptacle of the slide insert holder to form a slide insert and slide insert holder assembly, wherein one or more receptacles are formed by an alignment of the holes of the slide insert with the openings of the slide insert holder in the slide insert and slide insert holder assembly, wherein the one or more receptacles are configured to receive the one or more inserts.

According to a second broad aspect, the present disclosure provides a method of utilizing a device to learn to spell comprising: inserting a slide insert into a slide insert holder to form a slide insert and slide insert holder assembly, wherein the slide insert has a holding portion and an insertion region, and one or more holes disposed within the insertion region; wherein the slide insert holder has one or more corresponding openings to the holes disposed in the slide insert; forming one or more receptacles by aligning the holes of the slide insert with the openings of the slide insert holder in the slide insert and slide insert holder assembly; and inserting one or more inserts into the one or more receptacles to form spelling words, wherein the inserts are marked to correspond to a letter of the alphabet, wherein the slide insert comprises a picture and the one or more inserts is inserted into the one or more receptacles and arranged in an order to spell the name of the picture on the slide insert.

According to a second broad aspect, the present disclosure provides a method of utilizing an educational device comprising: one of more inserts; and a holding tray having recessed holes for receiving and retaining the one or more inserts; wherein each of the one or more inserts comprises an extension extending from a base portion of the one or more inserts, wherein the extension is keyed to match the recessed holes disposed within the holding tray, wherein the extension comprises one or more cutouts and projections disposed along a portion thereof, wherein each recessed hole comprises one or more cutouts and projections, wherein the extension is configured to fit in mated relationship within the recessed hole in a mated assembly, such that the one or more cutouts and projections of the extension fits and is matched with the one or more projections and cutouts of the recessed hole, respectively.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 illustrates a character retention system for a plurality of inserts within a base according to one embodiment of the present disclosure.

FIG. 2 illustrates a detailed view of inserts and corresponding retaining holes within a base application according to one embodiment of the present disclosure.

FIG. 3 illustrates a slide insert and slide insert holder arrangement according to one embodiment of the present disclosure.

FIG. 4 illustrates an exemplary process for manipulating a slide insert with respect to a slide insert holder according to one embodiment of the present disclosure.

FIG. 5 illustrates a process for manipulating inserts within a slide insert and slide insert holder arrangement according to one embodiment of the present disclosure.

FIG. 6 illustrates perspective views of an assembly of inserts properly seated within a slide insert and slide insert holder arrangement according to one embodiment of the present disclosure.

FIG. 7 illustrates another exemplary process for manipulating a slide insert with respect to a slide insert holder according to one embodiment of the present disclosure.

FIG. 8 illustrates another exemplary process for manipulating inserts within a slide insert and slide insert holder arrangement according to one embodiment of the present disclosure.

FIG. 9 illustrates another exemplary process for manipulating a slide insert with respect to a slide insert holder according to one embodiment of the present disclosure.

FIG. 10 illustrates another exemplary process for manipulating inserts within a slide insert and slide insert holder arrangement according to one embodiment of the present disclosure.

FIG. 11 illustrates a character retention system for a plurality of inserts within a specialized base application according to one embodiment of the present disclosure.

FIG. 12 illustrates a detailed view of inserts and corresponding retaining holes within a specialized base application according to one embodiment of the present disclosure.

### DETAILED DESCRIPTION OF THE INVENTION

### Definitions

Where the definition of terms departs from the commonly used meaning of the term, applicant intends to utilize the definitions provided below, unless specifically indicated.

It is to be understood that the foregoing general description and the following detailed description are exemplary and explanatory only and are not restrictive of any subject matter claimed. In this application, the use of the singular includes the plural unless specifically stated otherwise. It must be noted that, as used in the specification and the appended claims, the singular forms “a,” “an” and “the” include plural referents unless the context clearly dictates otherwise. In this application, the use of “or” means “and/or” unless stated otherwise. Furthermore, use of the term “including” as well as other forms, such as “include”, “includes,” and “included,”is not limiting.

For purposes of the present disclosure, the term “comprising”, the term “having”, the term “including,” and variations of these words are intended to be open-ended and mean that there may be additional elements other than the listed elements.

For purposes of the present disclosure, directional terms such as “top,” “bottom,” “upper,” “lower,” “above,” “below,” “left,” “right,” “horizontal,” “vertical,” “up,” “down,” etc., are used merely for convenience in describing the various embodiments of the present disclosure. The embodiments of the present disclosure may be oriented in various ways. For example, the diagrams, apparatuses, etc., shown in the drawing figures may be flipped over, rotated by 90° in any direction, reversed, etc.

For purposes of the present disclosure, a value or property is “based” on a particular value, property, the satisfaction of a condition, or other factor, if that value is derived by performing a mathematical calculation or logical decision using that value, property or other factor.

For purposes of the present disclosure, it should be noted that to provide a more concise description, some of the quantitative expressions given herein are not qualified with the term “about. ” It is understood that whether the term “about” is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

For purposes of the present disclosure, the term “alphabet” refers to a set of letters or symbols in a fixed order, used to represent the basic sounds of a language. Such alphabet may include a set of graphs or characters used to represent the phonemic structure of a language. The characters are arranged in a definite order or sequence.

For purposes of the present disclosure, the term “character” refers to a graphic symbol (such as a hieroglyph or alphabet letter) used in writing or printing or a symbol (such as a letter or number) that represents information.

For purposes of the present disclosure, the term “dimensionally” refers to a way that relates to the dimensions of something, such as its height, length, or width.

For purposes of the present disclosure, the term “indicia” refers to signs, indications, or distinguishing marks.

For purposes of the present disclosure, the term “number” refers to an arithmetical value, expressed by a word, symbol, or figure, representing a particular quantity and used in counting and making calculations and for showing order in a series or for identification.

### Description

While the invention is susceptible to various modifications and alternative forms, specific embodiments thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

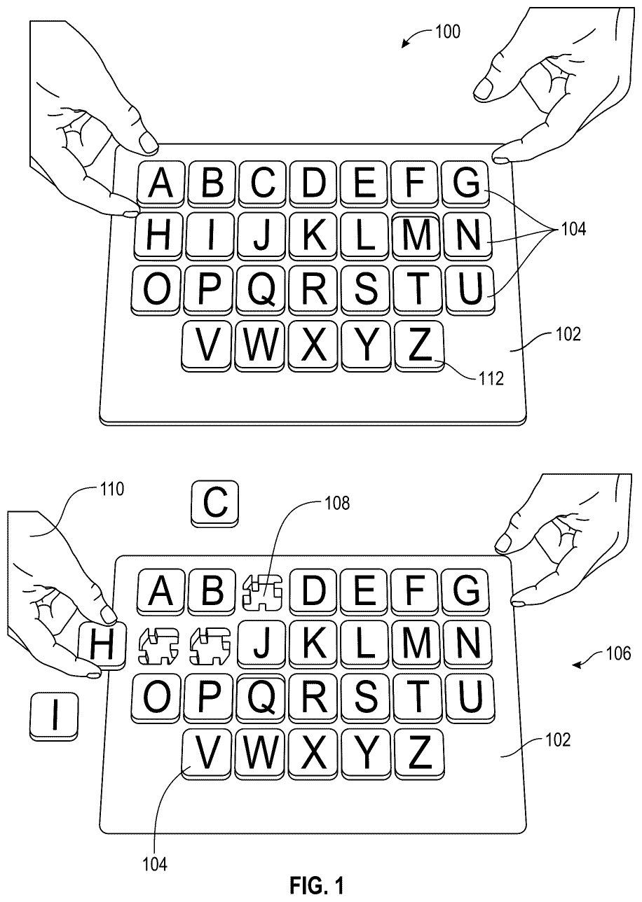

Turning to FIG. 1, a character insert retention system 100 includes a holding tray or base 102 for retaining a plurality of inserts 104. Inserts 104 may be described as character inserts having graphic indicia on a top face 112 representing, for example, a letter of an alphabet or number.

As shown in view 106, base 102 may contain a plurality of recessed holes 108 configured to receive and retain inserts 104. Recessed holes 108 may be appropriately dimensioned to receive a respective insert 104 which as a corresponding shape to match its respective recessed hole 108. In some disclosed embodiments, recessed holes 108 may be configured with cutouts that correspond to a unique shape for receiving a respective insert 104. A user hand 110 may place insert 104 corresponding to the unique shape of its respective recessed hole 108. Thus, not every insert 104 will fit into any recessed hole 108. Only the correct insert 104 that is dimensionally matched exactly to fit its corresponding recessed hole 108 will fit and be retained therein.

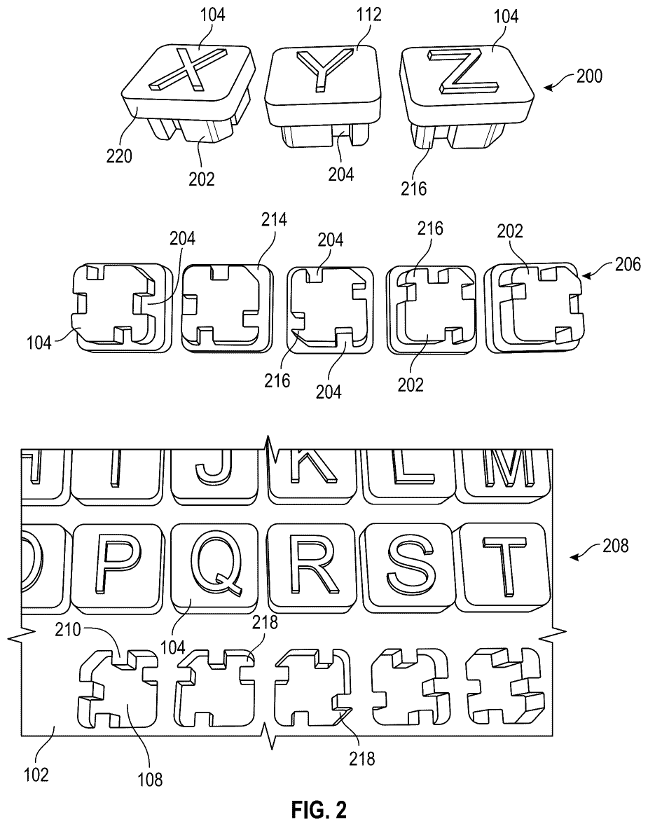

View 200 of FIG. 2 illustrates a perspective view of inserts 104. As shown, inserts 104 may include a base portion 220 having a top face 112 and a bottom surface 214. Extensions 202 may extend, for example, from bottom surface 214 of base portion 220. In some embodiments, the outer perimeter of extension 202 may be smaller than the outer perimeter of base portion 220. Extensions 202 may include one or more cutouts 204 disposed along a portion of extension 202. View 206 illustrates a bottom view of inserts 104. As can be seen, more than one cutout 204 may be configured into extension 202 of each insert 104 to remove material at appropriate locations. The cutouts 204 may be variably positioned along locations of extension 202 such that a final dimension of each extension 202 of a respective insert 104 is unique. Invariably, cutouts may also form one or more projections 216 or projection-type geometrical shapes along surfaces of extensions 202.

In view 208 of FIG. 2, recessed holes 108 formed in base 102 may also include one or more cutouts 210 variably positioned along locations of recessed hole 108. In some disclosed embodiments, cutouts 210 may be variably configured, for example, within or along a perimeter of recessed hole 108. It is possible that cutouts 210 also invariably form one or more projections 218 including projection-type geometrical shapes within or along a perimeter of recessed hole 108. Disclosed embodiments provide that recessed holes 108 may be configured with a matching cutout and projection design to precisely match and receive a unique dimensional shape of extension 202 of a respective insert 104. This may include mating extension 202 having unique cutouts 204 and projections 216 with corresponding recesses in the recessed hole 108 of base 102. Thus, extension 202 is configured to fit in mated relationship within recessed hole 108 in a mated assembly, such that the one or more cutouts 204 and projections 216 of the extension 202 fits and is matched with the one or more projections 218 and cutouts 210 of the recessed hole 108, respectively. Thus, extension 202 may be inserted into a corresponding recessed hole 108 such that bottom surface 214 of insert 104 is rested flush with a top surface of base 102 to achieve a fully seated mated relationship.

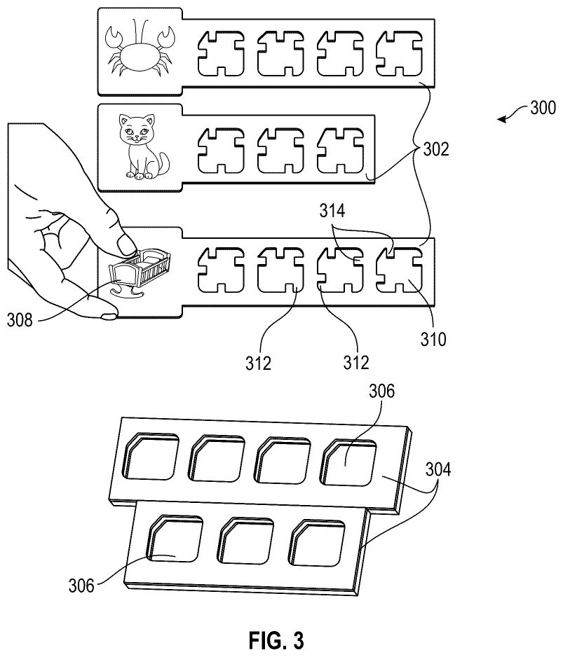

In another disclosed embodiment, a plurality of slide inserts 300 is illustrated in FIG. 3. The plurality of slide inserts 300 may comprise various types of slide inserts 302 having one or more plurality of slide holes 310. Each slide hole 310 may include one or more cutouts 312. The cutouts 312 may be variably positioned along locations such as along a perimeter of holes 310. It is possible that cutouts 312 also invariably form one or more projections 314 including projection-type geometrical shapes within or along a perimeter of hole 310. Thus, each hole 310 having cutouts 312 may be uniquely configured and dimensioned to correspond to receive a shape of extension 202 of insert 104. Accordingly, disclosed embodiments provide that holes 310 may be configured with a matching cutout and projection design to precisely match and receive the unique dimensional shape of extension 202 of a respective insert 104. This may include inserting extension 202 having unique cutouts 204 and projections 216 into mated relationship with corresponding projections 314 and cutouts 312, respectively, of hole 310 of slide insert 302. Thus, extension 202 is configured to fit in mated relationship within hole 310 in a mated assembly, such that the one or more cutouts 204 and projections 216 of the extension 202 fits and is matched with the one or more projections 314 and cutouts 312 of the hole 310, respectively. In this manner, extension 202 of insert 104 may be appropriately keyed to be received by a correspondingly dimensioned hole 310 of slide insert 302. Thus, hole 310 is uniquely keyed to only receive the appropriately dimensioned extension 202 of insert 104.

Slide insert 302 may include indicia or picture 308 representing an object including, by way of examples, a cat, crab, crib, etc. Thus picture 308 may be disposed at one end of slide insert 302 and holes 310 may be configured along a remaining surface of slide insert 302 thereof. Disclosed embodiments may provide slide insert holders 304 having openings 306 cut out at appropriate locations along portions of slide insert holders 304. As further described below, slide insert holders 304 are configured to receive slide insert 302. Once fully received within slide insert holder 304, slide holes 310 will align with openings 306 of slide insert holders 304 as further described and shown.

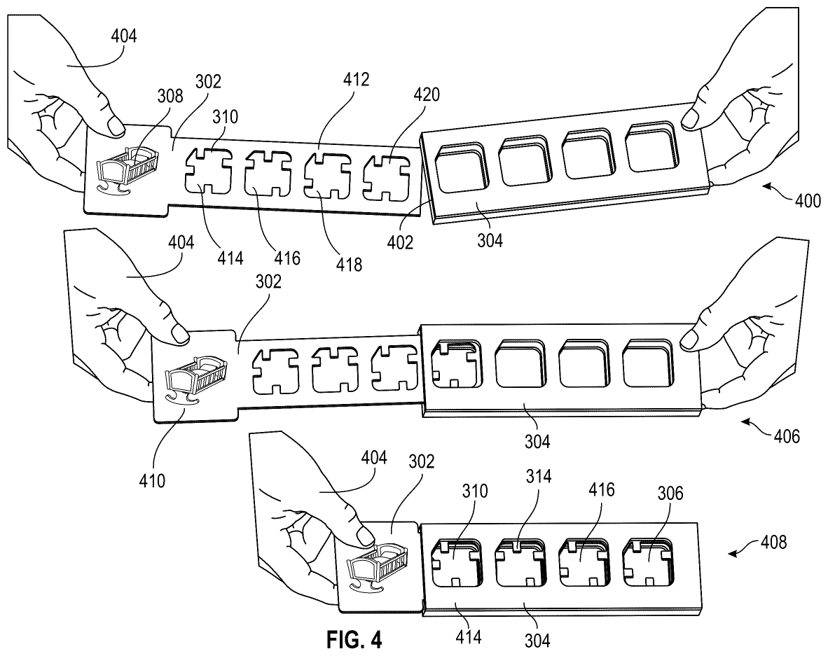

View 400 of FIG. 4 illustrates a user 404 manipulating slide insert 302 into a slot receptable 402 configured, for example, in an end of slide insert holder 304. Slot receptable 402 is appropriately dimensioned to receive slide insert 302 therein. As shown in view 406, once slide insert 302 begins to be inserted within slot receptable 402 of slide insert holder 304, holes 310 of slide insert 302 begin to pass by openings 306 of slide insert holder 304 until slide insert 302 is fully inserted into slide insert holder 304. Once slide insert 302 is fully inserted into slide insert holder 304 to form a slide insert holder 304 and slide insert 302 assembly 414, as shown in view 408, each hole 310 of slide insert 302 is aligned with openings 306 of slide insert holder 304. Openings 306 of slide insert holder 304 are appropriately dimensioned to provide and allow access to a corresponding hole 310 in slide insert 302 for insertion of a properly keyed extension 202 of insert 104. Thus, the properly aligned assembly of the hole 310 of slide insert 302 with openings 306 of slide insert holder 304 thereby form receptacles in the insert holder 304 and slide insert 302 assembly 414 for accepting matching or properly keyed extension 202 of insert 104.

Referencing FIGS. 3 and 4, it is readily appreciated that various amounts of holes 310 may be configured within slide inserts 302. Likewise, various amounts of openings 306 may be configured within slide insert holders 304. Thus, disclosed embodiments provide that slide insert holders 304 may be configured with an appropriate number of openings 306 in accordance with a corresponding number of matching holes 310 of a slide insert 302 intended to be inserted therein.

The precise number of holes 310 provided in slide inserts 302 depends on user preference. Likewise, the exact number of openings 306 within slide insert holders 304 may also depend on user preference. In one preferred embodiment, the number of holes 310 provided in slide inserts 302 corresponds to the same number of openings 306 within slide insert holders 304.

A picture 308 of an object may be disposed on a holding or handling portion 410 of slide insert 302. Holes 310 may be configured in an insertion region 412 of slide insert 302. By grasping holding or handling portion 410 a user 404 may more easily manipulate slide insert 302 such as into slot receptable 402 of slide insert holder 304. In one configuration, holding or handling portion 410 may be designed to have a slightly larger dimension than insertion region 412. Thus, the slightly larger dimension of holding or handling portion 410 may serve as a stop point when insertion region 412 is fully inserted within slot receptable 402 of slide insert holder 304 as shown in view 408. In this fully inserted configuration, the surface of the larger dimension of holding or handling portion 410 may be fully abutted against the exterior of slide insert holder 304. In accordance with disclosed embodiments, when slide insert 302 is fully inserted within slide insert holder 304, holes 310 of slide insert 302 are positioned to fully align with corresponding openings 306 of slide insert holder 304 as shown in view 408.

Picture 308 may comprise any object. As shown for example in FIGS. 4-6, picture 308 of a crib is displayed in holding or handling portion 410 of slide insert 302. In preferred embodiments, the number of holes 310 in slide insert 302 is determined by the number of letters corresponding to the spelling of the name of the object displayed in picture 308. In the example displayed in FIGS. 4-6, picture 308 displays a crib. Thus, there are four holes 310 corresponding to each letter of the word that spells “CRIB.”

As discussed earlier, a letter may be attributed and displayed such as on a top face of insert 104. Extension 202 of insert 104 may be appropriately dimensioned (such as via a series of cut outs) to be appropriately keyed to fit within a corresponding hole 310 of slide insert 302. In the example of FIGS. 4-6, holes 310 are specifically and uniquely designed to receive inserts 104 to spell out the word “crib.” Accordingly, a respective position of each letter comprising the word “CRIB” is configured as holes 414, 416, 418 and 420. Hole 414 is only configured to receive an insert 104 corresponding to the letter “C.” Hole 416 is only configured to receive an insert 104 corresponding to the letter “R.” Hole 418 is only configured to receive an insert 104 corresponding to the letter “I.” Hole 420 is only configured to receive an insert 104 corresponding to the letter “B.”

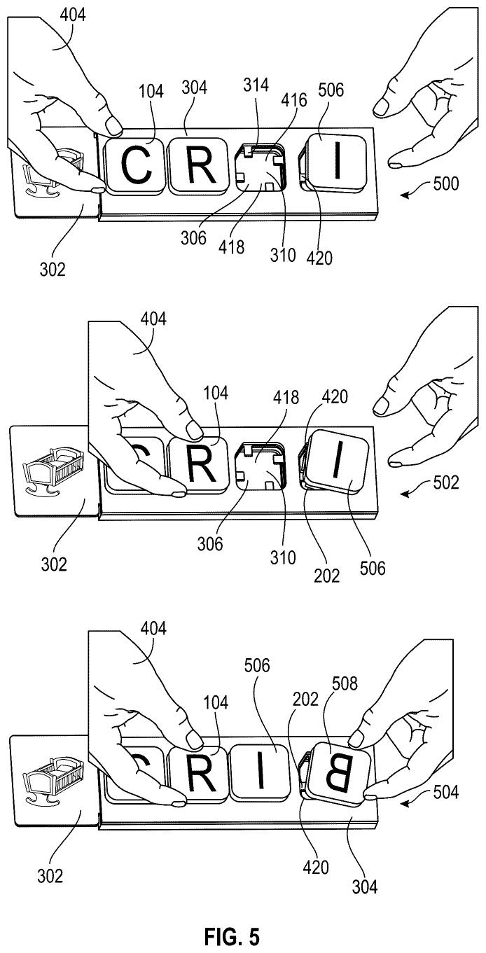

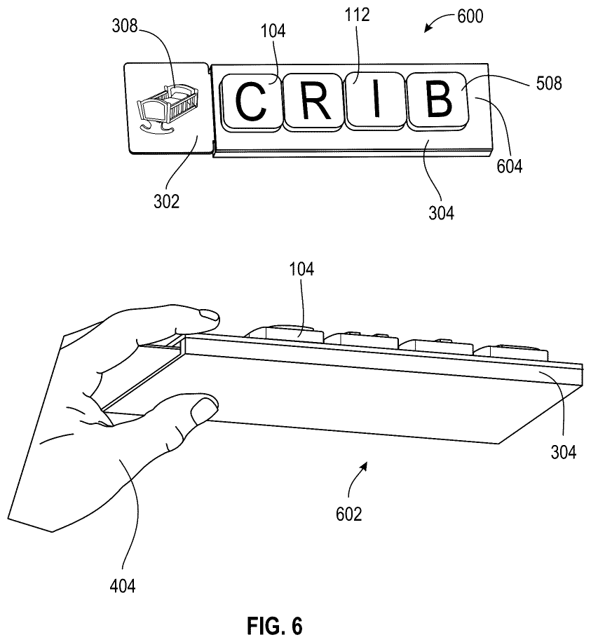

As illustrated in FIGS. 5-6, once slide insert 302 is fully inserted within slide insert holder 304, user 404 may attempt to manipulate inserts 104 into holes 310. Only the appropriately and uniquely configured insert 104 will fit correctly into a fully seated and mated position within hole 310 of slide insert 302 through opening 306 of slide insert holder 304. Thus, as shown in views 500 and 502 of FIG. 5, user 404 correctly seats inserts 104 for the letters “C” and “R” correctly within positional holes 414 and 416 (see FIG. 4), respectively. However, when insert 506 representing the letter “I” is attempted to be fitted in hole 420, its extension 202 is not properly keyed to fit within hole 420 no matter how much insert 506 is maneuvered or manipulated. Thus, it is not possible for extension 202 of insert 506 to fit in mated relation within hole 420. The extension 202 of insert 506 will only fit in mated relation within proper alignment at a position within corresponding hole 418 of slide insert 302 as shown, for example, when insert 506 is properly positioned and seated shown in view 504 of FIG. 5.

It is readily appreciated that some unique letters or symbols may be symmetrical. For example, the letter “I” may be visually viewed the same in more than one orientation as shown, for example, in view 504. If insert 506 were spun 180°, the face of insert 506 representing the letter “I” would still look the same. Thus, extension 202 of insert 506 may be appropriately designed and configured to mate directly within hole 310 of slide insert 302 in more than one position such that it is oriented and seated therein. Hence, in some embodiments, insert 506 may be manipulated to be seated in hole 418 in one orientation or in a second orientation while representing the same letter visually. A similar configuration and design may be applied to other symmetrical letters and/or symbols such as the letter “O” or numeral “0” as types of inserts 104 having corresponding holes 310 of slide inserts 302.

Turning again to view 504 of FIG. 5, it is noted that even though a lettered insert is located at a correct hole position, it still must be oriented correctly in order to fit in a full mated relationship through opening 306 of slide insert holder 304 into a fully seated position of hole 310 of slide insert 302. For example, insert 508 representing the letter “B” is disposed at a correct location for hole 420 (see also FIG. 4), however insert 508 is oriented upside down and will not fit within hole 420 through opening 306 in this orientation.

As shown in the top view 600 of FIG. 6, insert 508 must be properly manipulated into the correct orientation such that its respective extension 202 is aligned with hole 420 through opening 306 in order for insert 508 to be fully seated properly into slide insert holder 304. In this manner, bottom surface 214 of insert 508 is rested flush with a top surface 604 of slide insert holder 304 to achieve a full and proper seating of insert 508 within slide insert holder 304. As illustrated in the top view 600 and perspective bottom view 602 of FIG. 6, fully seated inserts 104 of each letter provides a physical and visual indication that each letter is correctly placed and oriented in the proper order. This is also a physical and visual indication that no more letters are required, since no more holes are available to fill within slide insert holder 304. Furthermore, when all the inserts 104 are fully seated in proper position, this also indicates that the resulting orientation of letters represented on the top faces 112 of the inserts 104 correctly spell the word corresponding to the picture 308 on slide insert 302. Thus, user 404 may be fully confident that the word is spelled correctly and that each letter is oriented properly. This facilitates learning by associating the correct spelling of an object in accordance with picture 308.

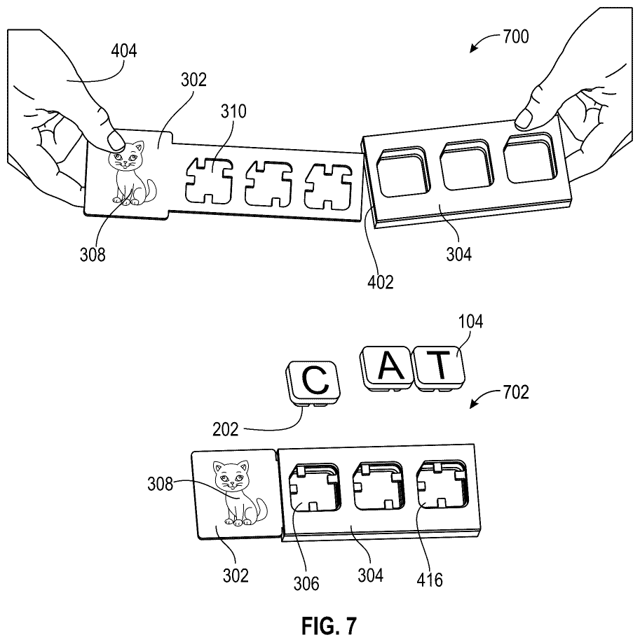

As previously discussed above, various amounts of holes 310 may be configured within slide inserts 302, for example, depending upon the amount of letters in an object which is desired for spelling. Likewise, various amounts of openings 306 may be configured within slide insert holders 304. This flexibility facilitates having an appropriately configured slide insert holder 304 to match the letter capability of a corresponding slide insert 302. In an exemplary embodiment, FIG. 7 illustrates another spelling example wherein slide insert 302 includes a cat picture 308 for spelling. There are, of course, three holes 310 corresponding to the three letters for “CAT” in this example. As shown in view 700, user 404 may manipulate slide insert 302 into slide insert holder 304 via slot receptacle 402. When fully inserted, as shown in view 702, the letters spelling “CAT” may be manipulated into position in an attempt to achieve the proper spelling corresponding to picture 308.

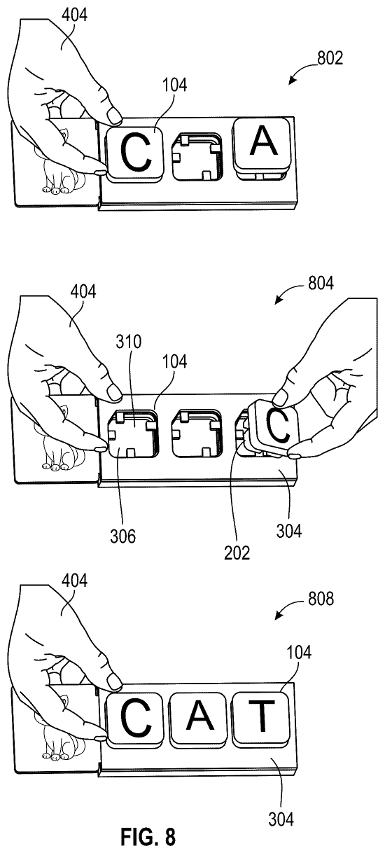

As shown in view 802 of FIG. 8, user 404 attempts to place the correct letters into proper position for spelling “CAT.” Insert 104 for the letter “C” is correct. Extension 202 of insert 104 representing the letter “C” must be properly keyed to match hole 310 of slide insert 302 at the shown position. However, insert 104 for the letter “A” is incorrect and will not be allowed to fit into hole 310 of slide insert 302. Extension 202 of insert 104 representing the letter “A” is not properly keyed to match hole 310 at the shown position.

Turning to view 804 of FIG. 8, user 404 may attempt to manipulate insert 104 representing the letter “C” into another position as shown. However, user 404 will be unsuccessful in orienting and properly seating insert 104 representing the letter “C” into hole 310, since extension 202 of insert 104 representing the letter “C” is not properly keyed to match hole 310 at the shown position.

Turning to view 806 of FIG. 8, each of the letters are oriented in the proper order corresponding to the proper spelling of the word “CAT.” Thus, each extension 202 of each insert 104 representing the letters “C,” “A,” and “T” are all properly keyed at each position shown to match respective holes 310 of slide insert 302.

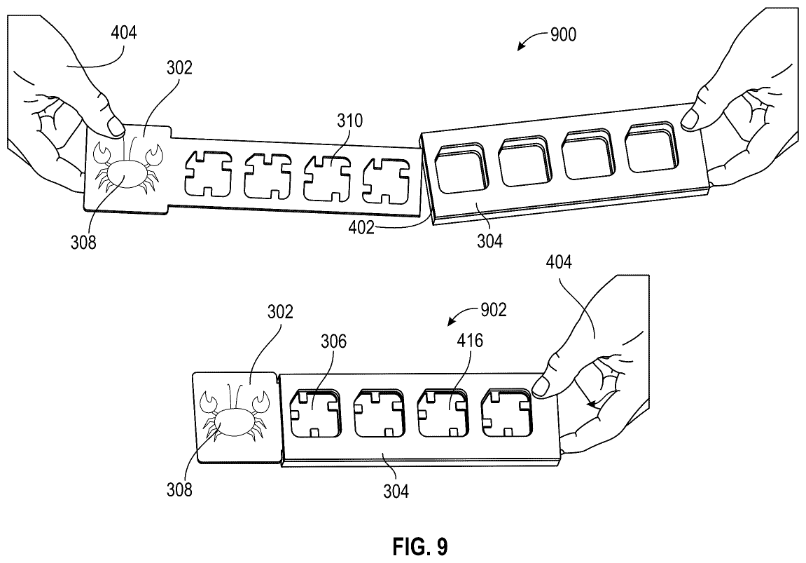

In yet another example, FIG. 9 illustrates another spelling example wherein slide insert 302 includes a crab picture 308 for spelling. In this example four holes 310 are provided corresponding to the four letters for “CRAB.” As shown in view 900, user 404 may manipulate slide insert 302 into slide insert holder 304 via slot receptacle 402. When fully inserted, as shown in view 902, the letters spelling “CRAB” may be manipulated into position in an attempt to achieve the proper spelling corresponding to picture 308.

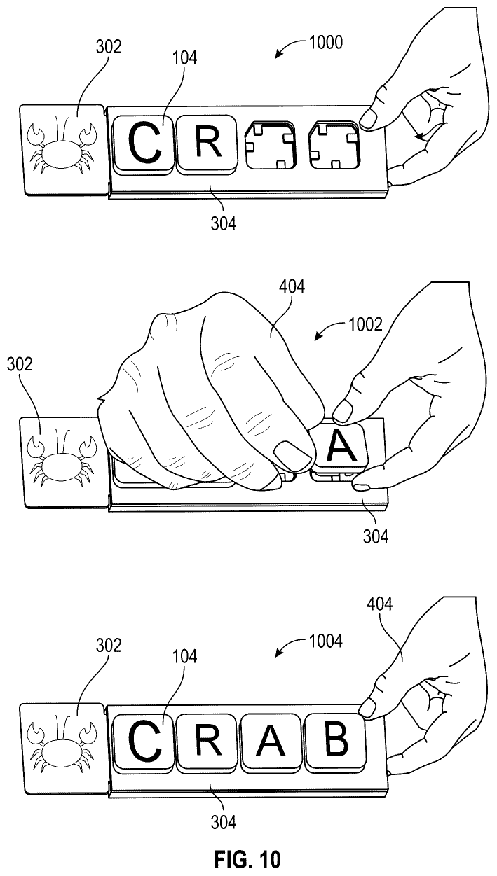

As shown in view 1000 of FIG. 10, user 404 may attempt to place the correct letters into proper position for spelling “CRAB.” Inserts 104 for the letters “C” and “R” are correct. Extension 202 of insert 104 representing the letter “C” must be properly keyed to match hole 310 of slide insert 302 at the shown position. Likewise, extension 202 of insert 104 representing the letter “R” must also be properly keyed to match hole 310 of slide insert 302 at the shown position. However, as illustrated in view 1002 of FIG. 10, insert 104 for the letter “A” is incorrect and will not be allowed to fit into hole 310 of slide insert 302. Extension 202 of insert 104 representing the letter “A” is not properly keyed to match hole 310 at the shown position.

Turning to view 1004 of FIG. 10, each of the letters are oriented in the proper order corresponding to the proper spelling of the word “CRAB.” Thus, each extension 202 of each insert 104 representing the letters “C,” “R,” “A,” and “T” are all properly keyed at each position shown to match respective holes 310 of slide insert 302.

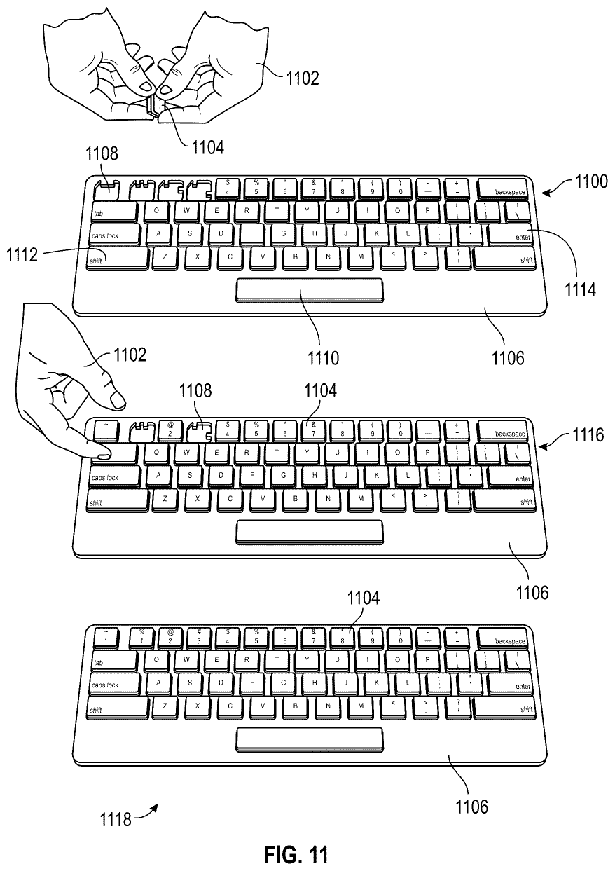

In another embodiment, alternative applications may be employed utilizing the disclosed design. Turning to views 1100 and 1116 of FIG. 11, a user 1102 may manipulate one or a plurality of inserts 1104 into insertion recessed holes 1108 of a keyboard base 1106. Inserts 1104 may comprise similar type design features as described above with respect to inserts 104. For example, turning to view 1200,

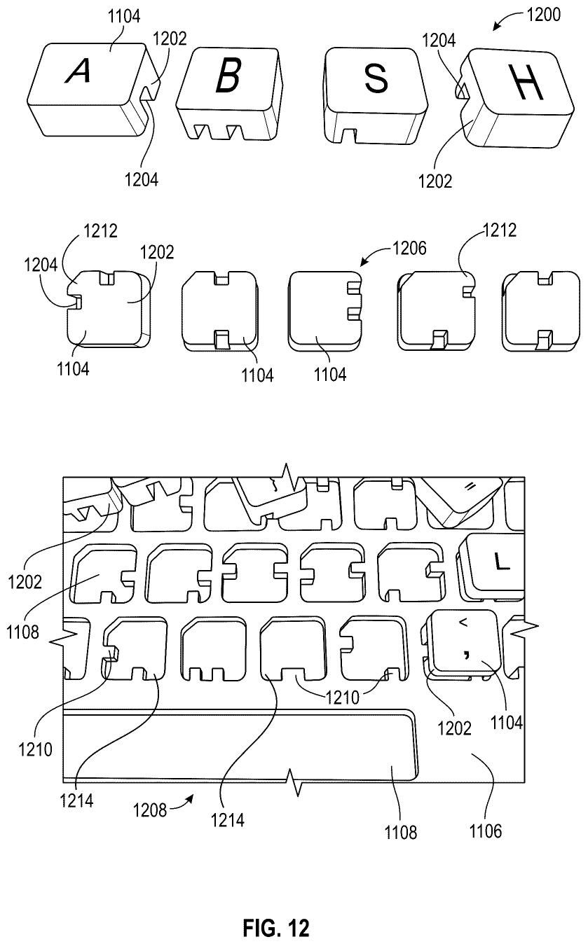

View 1200 of FIG. 12 illustrates a perspective view of inserts 1104. As shown, inserts 1104 may include an extended portion 1202. Extended portion 1202 may include one or more cutouts 1204. View 1206 illustrates a bottom view of inserts 1104. As can be seen, more than one cutout 1204 may be configured into extended portion 1202 of each insert 1104 to remove material at appropriate locations. The cutouts 1204 may be variably positioned along locations of extended portion 1202 such that a final dimension of each extended portion 1202 of a respective insert 1104 is unique. Invariably, cutouts may also form projections 1212 or projection-type geometrical shapes along surfaces of extended portion 1202.

Likewise, insertion recessed holes 1108 may also comprise similar type design features as described above with respect to holes 108.

In view 1208 of FIG. 12, recessed holes 1108 formed in keyboard base 1106 may also include one or more cutouts 1210 variably positioned along locations of recessed hole 1108. In some disclosed embodiments, cutouts 1210 may be variably configured, for example, within or along a perimeter of recessed hole 1108. It is possible that cutouts 1210 also invariably form projections 1214 including projection-type geometrical shapes within or along a perimeter of recessed hole 1108. Disclosed embodiments provide that recessed holes 1108 may be configured with a matching cutout and projection design to precisely match and receive a unique dimensional shape of extended portion 1202 of a respective insert 1104. This may include mating extended portion 1202 having unique cutouts 1204 and projections 1212 with corresponding recesses in the recessed hole 1108 of keyboard base 1106.

Inserts 1104 may be designed as special characters with varying dimensions such as including letters, keyboard shift key 1112, enter key 1114, space bar 1110, etc. Insertion recessed holes 1108 may be appropriately dimensioned to accept inserts 1104 in a mated relationship wherein the correct insert 1104 is dimensionally matched exactly to fit its corresponding recessed hole 1108. Each special character (such as keyboard shift key 1112, enter key 1114, space bar 1110) may, therefore, have a unique position on the keyboard base 1106 when placed in its fully seated position as shown in view 1118 of FIG. 11. In this manner, it is possible for user 1102 to learn the positioning of letters and special characters of a keyboard necessary, for example, in learning to type.

Having described the many embodiments of the present disclosure in detail, it will be apparent that modifications and variations are possible without departing from the scope of the invention defined in the appended claims. Furthermore, it should be appreciated that all examples in the present disclosure, while illustrating many embodiments of the invention, are provided as non-limiting examples and are, therefore, not to be taken as limiting the various aspects so illustrated.

For example, the disclosed embodiments may be employed as an educational device for learning including, but not limited to, spelling of words and learning and associating objects. Additional applications include learning locations of controls on devices such as utilizing lettering, numbering and special characters on keyboards. In other applications, disclosed embodiments may be employed or commissioned as a game for learning.

As one embodiment as a disclosed learning tool, a user is challenged to find the correct letters, for example, to spell out a word associated with or presented as a picture 308 on slide insert 302. In so doing, the user must correctly identify the correct letters and orient them in the proper order within an assembled slide insert holder 304 and slide insert 302 assembly 414 having receptacles 416 for accepting lettered inserts, for example. This may include learning to manipulate inserts representing letters or numbers by rotating, orienting, and reorienting the same to achieve a final goal of spelling a word correctly associated with an object represented as picture 308. Since the assembled slide insert holder 304 and slide insert 302 assembly 414 is keyed to only accept correspondingly keyed matching inserts, a user may learn by trial and error which lettered inserts are accepted within receptacles 416. The user knows an incorrect letter is selected or in a wrong position when an insert 104 is not accepted or is not fully or properly seated within a receptacle 416. Conversely, a user knows a correct letter is selected when an insert 104 is accepted and is fully or properly seated within a receptacle 416.

In another embodiment as a disclosed learning tool, a user is challenged to find the correct letters, symbols and/or special characters, for example, configured as inserts 104 and to correctly place inserts 102 in a holding tray or base 102. The holding tray or base 102 may be specifically designed as a predetermined object, such as a keyboard base 1106, for which the user is challenged to learn the placement of inserts 1104 inserted therein. In this embodiment, the user must correctly identify the correct letters, symbols and/or special characters, (represented as inserts 1104) and orient them in the proper order within specialized matching/keyed recessed holes 1108 disposed on keyboard base 1106. The aforementioned matching/keyed recessed holes 1108 may be designed as receptacles for accepting keyed extended portions 1202 of inserts 1104. This may include learning to manipulate inserts representing letters or numbers by rotating, orienting, and reorienting the same to achieve a final goal of placing the correct insert 1104 into the proper location disposed in keyboard base 1106. Recessed holes 1108 are keyed to only accept correspondingly keyed matching inserts 1104. A user may learn by trial and error which inserts 1104 are accepted within recessed holes 1108. The user knows an incorrect insert 1104 is selected or in a wrong position when the insert 1104 is not accepted or is not fully or properly seated within recessed holes 1108. Conversely, a user knows a correct insert 1104 is selected when the insert 1104 is accepted and is fully or properly seated within a recessed holes 1108.

All documents, patents, journal articles and other materials cited in the present application are incorporated herein by reference.

While the present disclosure has been disclosed with references to certain embodiments, numerous modifications, alterations, and changes to the described embodiments are possible without departing from the sphere and scope of the present disclosure, as defined in the appended claims. Accordingly, it is intended that the present disclosure not be limited to the described embodiments, but that it has the full scope defined by the language of the following claims, and equivalents thereof.

What is claimed is:

1. An educational device comprising:
a slide insert,
wherein the slide insert has a holding portion and an insertion region, and one or more holes disposed within the insertion region;
a slide insert holder,
wherein a slot receptacle is configured at one end of the slide insert holder for receiving the slide insert,
wherein the slide insert holder has one or more corresponding openings to the holes disposed in the slide insert; and
one of more inserts;
wherein the slide insert is inserted within the slot receptacle of the slide insert holder to form a slide insert and slide insert holder assembly,
wherein one or more receptacles are formed by an alignment of the holes of the slide insert with the openings of the slide insert holder in the slide insert and slide insert holder assembly,
wherein the one or more receptacles are configured to receive the one or more inserts.

2. The educational device of claim 1, wherein the one or more inserts is received by the one or more receptacles through the one or more corresponding openings of the slide insert holder and the one or more holes of the slide insert.

3. The educational device of claim 1, wherein each insert comprises an extension extending from a base portion of the insert.

4. The educational device of claim 1, wherein the extension of the insert is configured to be received by the receptacle through an opening of the slide insert holder and a hole of the slide insert.

5. The educational device of claim 3, wherein the extension is keyed to match one or more holes disposed within the insertion region.

6. The educational device of claim 3,
wherein the extension comprises one or more cutouts and projections disposed along a portion thereof,
wherein each hole of the slide insert comprises one or more cutouts and projections,
wherein the extension is configured to fit in mated relationship within the hole of the slide insert in a mated assembly, such that the one or more cutouts and projections of the extension fits and is matched with the one or more projections and cutouts of the hole, respectively.

7. The educational device of claim 1, wherein the one or more inserts are marked to correspond to a letter of the alphabet.

8. A method of utilizing a device to learn to spell comprising:
inserting a slide insert into a slide insert holder to form a slide insert and slide insert holder assembly,
wherein the slide insert has a holding portion and an insertion region, and one or more holes disposed within the insertion region;
wherein the slide insert holder has one or more corresponding openings to the holes disposed in the slide insert;
forming one or more receptacles by aligning the holes of the slide insert with the openings of the slide insert holder in the slide insert and slide insert holder assembly; and
inserting one or more inserts into the one or more receptacles to form spelling words, wherein the inserts are marked to correspond to a letter of the alphabet,
wherein the slide insert comprises a picture and the one or more inserts is inserted into the one or more receptacles and arranged in an order to spell the name of the picture on the slide insert.

9. The method of claim 8, wherein a slot receptacle is configured at one end of the slide insert holder for receiving the slide insert, wherein the slide insert is inserted within the slot receptacle of the slide insert holder to form the slide insert and slide insert holder assembly.

10. The method of claim 8, wherein each insert comprises an extension extending from a base portion of the insert, wherein the extension of the insert is configured to be received by the receptacle through an opening of the slide insert holder and a hole of the slide insert.

11. The method of claim 10, wherein the extension is keyed to match one or more holes disposed within the insertion region.

12. The method of claim 11, wherein in an attempt to spell the name of the picture on the slide insert, a user selects. one or more inserts to place it within the one or more receptacles in a seated arrangement, wherein the user manipulates an orientation of the one or more inserts if it does not seat properly within the one or more receptacles or selects another one or more inserts to place it within the one or more receptacles in a seated arrangement until the name of the picture is spelled correctly.

13. The method of claim 12, wherein the user associates an incorrect letter placement of the one or more inserts within the one or more receptacles by recognizing that the one or more inserts does not seat correctly.

14. The method of claim 12, wherein the user associates a correct letter placement of the one or more inserts within the one or more receptacles by recognizing that the one or more inserts does seat correctly.

15. The method of claim 8,
wherein the extension comprises one or more cutouts and projections disposed along a portion thereof,
wherein each hole of the slide insert comprises one or more cutouts and projections,
wherein the extension is configured to fit in mated relationship within the hole of the slide insert in a mated assembly, such that the one or more cutouts and projections of the extension fits and is matched with the one or more projections and cutouts of the hole, respectively.

16. The method of claim 15, wherein in an attempt to spell the name of the picture on the slide insert, a user selects. one or more inserts to place it within the one or more receptacles in a seated arrangement, wherein the user manipulates an orientation of the one or more inserts if it does not seat properly within the one or more receptacles or selects another one or more inserts to place it within the one or more receptacles in a seated arrangement until the name of the picture is spelled correctly.

17. The method of claim 16, wherein the user associates an incorrect letter placement of the one or more inserts within the one or more receptacles by recognizing that the one or more inserts does not seat correctly.

18. The method of claim 16, wherein the user associates a correct letter placement of the one or more inserts within the one or more receptacles by recognizing that the one or more inserts does seat correctly.

19. An educational device comprising:
one of more inserts; and
a holding tray having recessed holes for receiving and retaining the one or more inserts;
wherein each of the one or more inserts comprises an extension extending from a base portion of the one or more inserts,
wherein the extension is keyed to match the recessed holes disposed within the holding tray,
wherein the extension comprises one or more cutouts and projections disposed along a portion thereof,
wherein each recessed hole comprises one or more cutouts and projections,
wherein the extension is configured to fit in mated relationship within the recessed hole in a mated assembly, such that the one or more cutouts and projections of the extension fits and is matched with the one or more projections and cutouts of the recessed hole, respectively.

20. The educational device of claim 19, wherein the one or more inserts are marked to correspond to a letter of the alphabet or are designated as specialized characters, numbers or words.

21. The educational device of claim 19, wherein the holding tray comprises a keyboard configuration.
